(19) United States
(12) Patent Application Publication
(10) Pub. No.: US 2026/0196749 A1
(43) Pub. Date: Jul. 9, 2026

(54) LAMINATED BUSBAR AND TERMINAL BLOCK

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventors: Yasuhiro KUDO, Mie (JP); Daisuke HASHIMOTO, Mie (JP); Kentaro TACHI, Mie (JP); Yoshitomo TSUJII, Mie (JP)

(21) Appl. No.: 19/129,305

(22) PCT Filed: Nov. 7, 2023
(86) PCT No.: PCT/JP2023/040047

§ 371 Date: May 13, 2025

(30) Foreign Application Priority Data
Nov. 21, 2022 (JP) 2022-185451

(51) Int. Cl. H01R 9/24

(52) U.S. Cl. CPC H01R 9/24

(57) ABSTRACT

A laminated busbar is formed into a long shape and includes a plurality of busbars laminated. Each of the plurality of busbars includes a fixing hole. Inner peripheral surfaces of the fixing holes of the plurality of busbars are continuous along a lamination direction of the plurality of busbars and form a surface shape collectively punched with the plurality of busbars laminated.

### TECHNICAL FIELD

The present disclosure relates to a laminated busbar and a terminal block.

### BACKGROUND

Patent Document 1 discloses that, in a terminal block provided with a busbar, if a motor-side connection terminal moves, the busbar having a large rigidity cannot absorb that movement since being unable to follow that movement. Further, Patent Document 1 also discloses that, by interposing a braided wire between terminals, vibration applied to the terminals is absorbed by the braided wire.

### PRIOR ART DOCUMENT

Patent Document
Patent Document 1: International Publication No. WO 2011/055806

### SUMMARY OF THE INVENTION

### Problems to be Solved

To reduce the rigidity of the busbar, it has been studied to constitute a laminated busbar by a laminate of thin metal plates. In laminating the thin metal plates, it is desired to suppress position shifts of fixing holes.

Accordingly, it is aimed to suppress position shifts of fixing holes in a laminated busbar.

### Means to Solve the Problem

A laminated busbar of the present disclosure is formed into a long shape and provided with a plurality of busbars laminated, each of the plurality of busbars including a fixing hole, and inner peripheral surfaces of the fixing holes of the plurality of respective busbars being continuous along a lamination direction of the plurality of busbars, the inner peripheral surfaces forming a surface shape collectively punched with the plurality of busbars laminated.

Further, a terminal block of the present disclosure is to be fixed to a device and provided with the above laminated busbar and a block body to be fixed to the device while holding the laminated busbar.

### Effect of the Invention

According to the present disclosure, position shifts of fixing holes can be suppressed.

### BRIEF DESCRIPTION OF THE DRAWINGS

FIG. 1 is a perspective view showing a laminated busbar according to a first embodiment.

FIG. 2 is a partial section along II-II of FIG. 1.

FIG. 3 is a diagram showing an example of a manufacturing method of the laminated busbar.

FIG. 4 is a perspective view showing a laminated busbar according to a second embodiment.

FIG. 5 is a perspective view showing the laminated busbar.

FIG. 6 is a diagram showing an example of a manufacturing method of the laminated busbar.

FIG. 7 is a perspective view showing a laminated busbar according to a modification of the second embodiment.

FIG. 8 is a perspective view showing a laminated busbar according to another modification of the second embodiment.

FIG. 9 is a schematic diagram showing a mechanical and electrical integration unit incorporated with a terminal block according to a third embodiment.

### DETAILED DESCRIPTION TO EXECUTE THE INVENTION

### Description of Embodiments of Present Disclosure

First, embodiments of the present disclosure are listed and described.

The laminated busbar of the present disclosure is as follows.
(1) The laminated busbar of the present disclosure is formed into a long shape and provided with a plurality of busbars laminated, each of the plurality of busbars including a fixing hole, and inner peripheral surfaces of the fixing holes of the plurality of respective busbars being continuous along a lamination direction of the plurality of busbars, the inner peripheral surfaces forming a surface shape collectively punched with the plurality of busbars laminated.

According to this laminated busbar, since the fixing holes of the plurality of respective busbars are formed by being collectively punched with the plurality of busbars laminated, position shifts of the fixing holes are suppressed in the laminated busbar.
(2) In the laminated busbar of (1), at least one of the plurality of busbars may include a shear burr located on an edge of the fixing hole, at least one of the plurality of busbars may include a burr accommodating portion on an edge of the fixing hole, the shear burr being located in the burr accommodating portion, and the inner peripheral surfaces of the fixing holes of the plurality of respective busbars may be continuous along the lamination direction with the shear burr located in the burr accommodating portion. In this case, since the shear burr is located in the burr accommodating portion, the fixing holes are hardly shifted in position.
(3) The laminated busbar of (1) or (2) may be further provided with a folded portion linking the plurality of busbars.

In this case, since the plurality of busbars are linked by the folded portion, collective punching is easily performed. Further, the laminated state of the plurality of busbars can be held by the folded portion.
(4) In the laminated busbar of (3), the folded portion may be formed in a part in an extension direction of the laminated busbar.

In this case, the plurality of busbars are held in the laminated state in a part formed with the folded portion, out of the laminated busbar, and the plurality of busbars can be easily deformed to pass each other in other parts.
(5) In the laminated busbar of (4), the folded portion may be formed in a lateral region of the fixing holes in the extension direction of the laminated busbar.

In this case, position shifts of the fixing holes are hardly shifted in position by the folded portion located in the lateral region of the fixing holes. The laminated busbar can be easily deformed in a part where the fixing holes are not present, out of the laminated busbar.
(6) In the laminated busbar of (4) or (5), the laminated busbar may be bent at a bent portion in an intermediate part in the extension direction of the laminated busbar, and the folded portion may be formed in a lateral region of the bent portion.

In this way, the laminated busbar is hardly shifted in position at the bent portion.
(7) In the laminated busbar of any one of (1) to (6), the plurality of busbars may include a first outer busbar exposed on one side in the lamination direction and a second outer busbar exposed on the other side in the lamination direction, and the laminated busbar may be further provided with a holding piece for holding the plurality of busbars in a laminated state by extending from a side edge of the first outer busbar toward an outer surface of the second outer busbar.

The plurality of busbars are held in the laminated state by this holding piece.

Further, the terminal block of the present disclosure is as follows.
(8) The terminal block of the present disclosure is to be fixed to a device and provided with the laminated busbar of any one of (1) to (7) and a block body to be fixed to the device while holding the laminated busbar.

In this case, the terminal block can be provided which can absorb position shifts by the laminated busbar.

### Details of Embodiments of Present Disclosure

Specific examples of a laminated busbar and a terminal block of the present disclosure are described below with reference to the drawings. Note that the present disclosure is not limited to these illustrations, but is represented by claims and intended to include all changes in the scope of claims and in the meaning and scope of equivalents.

### First Embodiment

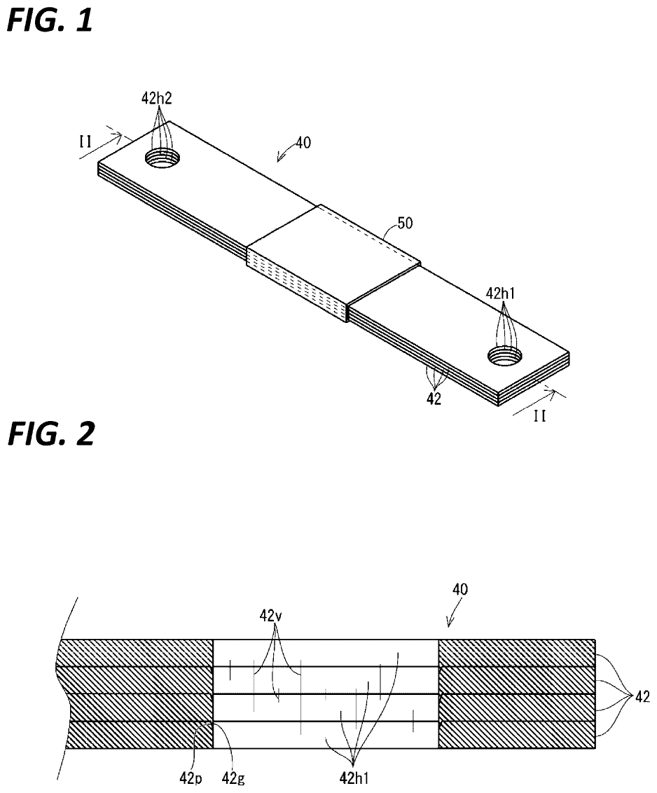

Hereinafter, a laminated busbar according to a first embodiment is described. FIG. 1 is a perspective view showing a laminated busbar 40. FIG. 2 is a partial section along II-II of FIG. 1.

The laminated busbar 40 is an electrically conductive member formed into a long shape. The laminated busbar 40 may extend straight or may be bent at a midway position. In this embodiment, the laminated busbar 40 extends straight.

The laminated busbar 40 is provided with a plurality of busbars 42 laminated. The busbars 42 are thinner than the entire laminated busbar 40. For example, the busbar 42 may have a thickness of 0.3 mm to 1 mm. The busbar 42 is made of a metal plate of copper, copper alloy, aluminum, aluminum alloy or the like. The busbar 42 is formed into an elongated shape. In the laminated busbar 40, the plurality of busbars 42 are overlapped with extension directions thereof aligned, wherefore the laminated busbar 40 is also formed into an elongated shape.

More specifically, the laminated busbar 40 is formed into a rectangular shape long in one direction. It is also assumed that end parts of the laminated busbar 40 are formed into a rounded shape. The number of the busbars 42 to be overlapped in the laminated busbar 40 is arbitrary.

The busbar 42 may include metal plating such as nickel plating. Metal plating may be applied only to surface forming parts of the laminated busbar 40.

Each of the plurality of busbars 42 includes fixing holes 42h1, 42h2. The fixing holes 42h1, 42h2 are, for example, holes, through which screws are inserted. In this embodiment, the fixing hole 42h1 is formed in one end of the busbar 42, and the fixing hole 42h2 is formed in the other end. The fixing hole 42h1 may be formed only in the one end of the busbar 42. A fixing hole may be formed in an intermediate part in an extension direction of the busbar 42.

In one end of the laminated busbar 40, the fixing holes 42h1 of the plurality of busbars 42 are arranged to overlap each other. The inner peripheral surfaces of the plurality of fixing holes 42h1 are continuous along a lamination direction of the plurality of busbars 42, and form a surface shape collectively punched with the plurality of busbars 42 laminated. That is, since the plurality of busbars 42 are collectively punched in a laminated state, the inner peripheral surfaces of the plurality of fixing holes 42h1 are assumed to be aligned at the same position in the extension direction of the busbars 42. That is, center axes of the plurality of fixing holes 42h1 are located on the same straight line and diameters of the plurality of fixing holes 42h1 are equal. Thus, the inner peripheral surfaces of the plurality of fixing holes 42h1 are assumed to be continuous without forming any step along the lamination direction of the plurality of busbars 42. Interlayer boundaries of the plurality of fixing holes 42h1 may remain or may not remain as streaky traces or the like.

Further, at least one of the plurality of busbars 42 is thought to include a shear burr 42p located on the edge of the fixing hole 42h1 (see FIG. 2). The shear burr 42p is a burr produced in forming the fixing hole 42h1, and assumed to be formed along a peripheral edge extruded by a press, out of the fixing hole 42h1. The shear burr 42p may be formed over the entire peripheral edge of the fixing hole 42h1 or may be formed on a part of the peripheral edge.

Further, at least one of the plurality of busbars 42 is thought to include a burr accommodating portion 42g, into which the shear burr 42p enters, on the edge of the fixing hole 42h1 (see FIG. 2). The burr accommodating portion 42g is a part formed by being pressed and recessed by a shearing die pressing the busbar 42 or by the entrance of the shear burr 42p formed by shearing extrusion. Since the plurality of busbars 42 are collectively punched, a configuration in which the shear burr 42p enters the burr accommodating portion 42g is realized near a boundary between the adjacent busbars 42. With the shear burr 42p located in the burr accommodating portion 42g, the inner peripheral surfaces of the fixing holes 42h1 of the plurality of busbars 42 are continuous along the lamination direction.

Note that the sizes, the shapes and the like of the shear burr 42p and the burr accommodating portion 42g in FIG. 2 are drawn for explanation. The shear burr 42p and the burr accommodating portion 42g may be a combination of finer projection and recess.

Further, in the case of collective punching with the plurality of busbars 42 laminated, it is also assumed that scratches 42v in a pressing direction formed by shearing are formed into streaks continuous between the inner peripheral surfaces of the fixing holes 42h1 adjacent in the lamination direction.

In contrast, if the plurality of busbars 42 are overlapped after the fixing holes 42h1 are separately formed in the plurality of busbars 42, it is assumed that the inner peripheral surfaces of the fixing holes 42h1 are shifted in position to form steps or gaps between the layers.

Also in the other end of the laminated busbar 40, the plurality of fixing holes 42h2 are formed to be continuous in the lamination direction, similarly to the fixing holes 42h1. Note that the fixing holes 42h1 and the fixing holes 42h2 may be holes different in shape and size.

The plurality of busbars 42 may be held in the laminated state by a lamination holding member 50. The lamination holding member 50 may be, for example, a thermally shrunk heat shrinkable tube. The heat shrinkable tube is, for example, a resin tube which is shape-memorized to be shrunk by heating. For example, the heat shrinkable tube is thermally shrunk in a state where the heat shrinkable tube before thermal shrinkage is externally fit to an intermediate part in a longitudinal direction of the laminated busbar 40. In this way, the plurality of busbars 42 is held in the laminated state.

The plurality of busbars 42 may be held in the laminated state by inserting parts in the longitudinal direction of the plurality of busbars 42 into a resin component.

The plurality of busbars 42 may be held in the laminated state by another configuration. For example, parts in the longitudinal direction of the plurality of busbars 42 may be joined by welding such as ultrasonic welding or resistance welding or may be joined by brazing such as soldering.

The plurality of busbars 42 may be press-worked to hold a joined state. A joint structure by prese working may be, for example, a structure called a crimp joint, a structure called a TOX (trademark) crimp or a structure called a mechanical clinch. The plurality of busbars 42 may be held in the joined state by screwing or the like.

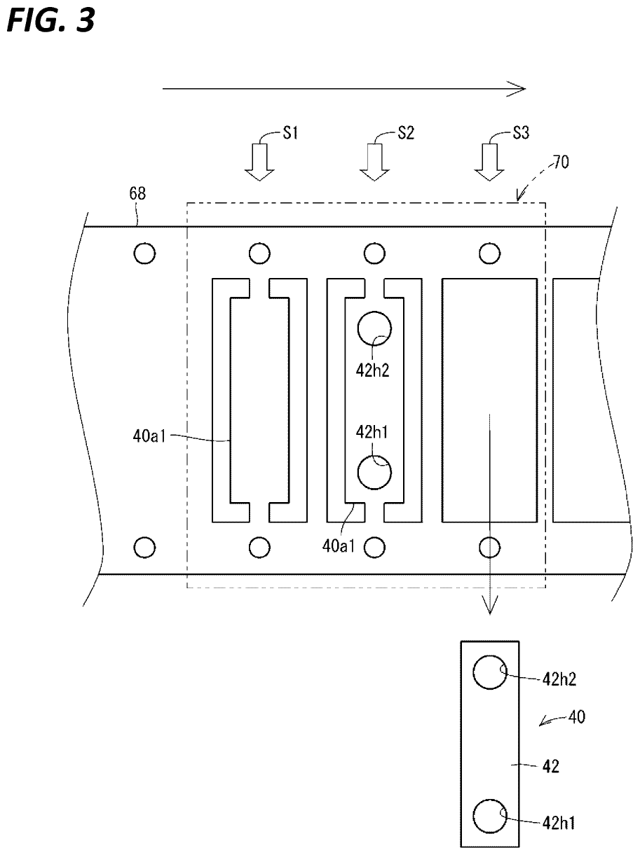

FIG. 3 shows an example of a manufacturing method of the laminated busbar 40.

For example, thin plates pulled out from a plurality of thin plate coils are laminated and consolidated into one. Both surfaces of each thin plate can be plated by applying plating to each thin plate before consolidation. Laminated thin plates 68 are fed to a progressive die device 70.

In a first stage S1 of the progressive die device 70, the plurality of thin plates 68 moving in the laminated state are punched into a shape corresponding to the outer shape of the laminated busbar 40. Parts of the outer peripheries of busbar outer shape parts 40a1 formed in this way remain to be coupled to the thin plates 68, whereby the punched busbar outer shape parts 40a1 can move in the laminated state in the progressive die device 70 together with the thin plates 68.

In a second stage S2 of the progressive die device 70, the fixing holes 42h1, 42h2 are collectively punched in the laminated busbar outer shape parts 40a1.

Subsequently, in a third stage S3 of the progressive die device 70, the coupling parts of the busbar outer shape parts 40a1 and the thin plates 68 are cut and the laminated busbar 40 is taken out. The lamination holding member 50 is externally mounted on the plurality of busbars 42 with the plurality of busbars 42 laminated. In this way, the laminated busbar 40 is manufactured. The plurality of busbars 42 may be joined to each other by welding, press working or the like before the coupling parts of the busbar outer shape parts 40a1 and the thin plates 68 are cut.

According to the laminated busbar 40 configured as described above, since the fixing holes 42h1, 42h2 of the plurality of busbars 42 are formed by collective punching with the plurality of busbars 42 laminated, the fixing holes 42h1 or 42h2 in the respective layers are hardly shifted in position.

Here, if the fixing holes 42h1 in the respective layers are shifted in position, there is a possibility that a common opening in the lamination direction becomes smaller than expected or the fixing holes 42h1 cannot be arranged at a correct position in design in the end part of the laminated busbar 40. In that case, since a screw cannot be smoothly inserted or the fixing holes 42h1 cannot be correctly arranged at a connection target position, a connecting operation using the laminated busbar 40 may not be possibly smoothly performed.

By suppressing the position shifts of the fixing holes 42h1 or 42h2 in the respective layers, the size of the common opening in the lamination direction can be set as desired and the fixing holes 42h1 or 42h2 can be correctly arranged for the connection target position, wherefore electrical connection utilizing the laminated busbar 40 can be easily realized. In this way, the manufacturing cost of the laminated busbar 40 can also be reduced.

Further, if the shear burr 42p enters the burr accommodating portion 42g between the adjacent busbars 42, position shifts of the fixing holes 42h1 or 42h2 hardly occur between the layers. Also from this perspective, the common opening of the fixing holes 42h1 or 42h2 in the lamination direction is easily set as desired.

### Second Embodiment

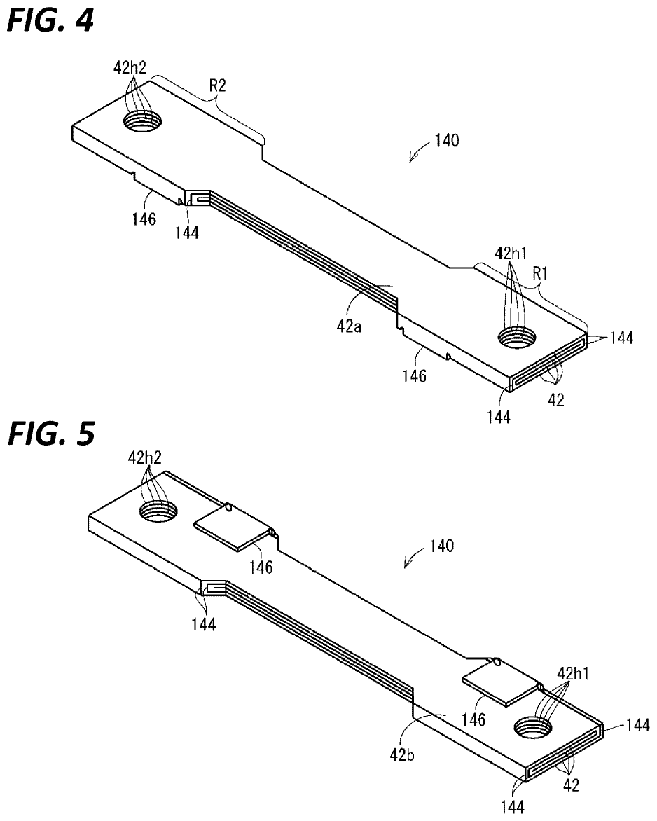

A laminated busbar according to a second embodiment is described. FIGS. 4 and 5 are perspective views showing a laminated busbar 140. Note that, in the description of the second embodiment, constituent elements similar to those described in the first embodiment are denoted by the same reference signs and not described.

The laminated busbar 140 according to the second embodiment differs from the laminated busbar 40 according to the first embodiment in that the laminated busbar 140 includes folded portions 144 linking a plurality of busbars 42.

The folded portion 144 may be present in any part of the busbar 42. The folded portion 144 may be located on an edge on a long side of the busbar 42 or may be located on an edge on a short side. In this embodiment, the folded portions 144 are present on the edges on the long sides of the busbar 42.

The folded portion 144 may be present over the entire edge on the long side of the busbar 42 or may be present on a part of the edge on the long side. In this embodiment, the folded portions 144 are formed in parts in an extension direction of the laminated busbar 140.

More specifically, the folded portions 144 are formed in a lateral region R1 of fixing holes 42h1 and in a lateral region R2 of fixing holes 42h2 in the extension direction of the laminated busbar 140. Since the folded portions 144 are not formed in an intermediate part in the extension direction of the laminated busbar 140, side surfaces of the busbars 42 are exposed. Since the folded portions 144 are formed in the lateral regions R1, R2 of the fixing holes 42h1, 42h2, the fixing holes 42h1 or 42h2 are easily held in a fixed positional relationship and hardly shifted in position. Further, since the plurality of busbars 42 can move in directions to pass each other in the intermediate part in the extension direction of the laminated busbar 140, the laminated busbar 140 can be easily bent in a thickness direction in the intermediate part in the extension direction.

The folded portions 144 may link the plurality of busbars 42 in any positional relationship. In this embodiment, the busbars 42 in a plurality of layers are coupled into a flat spiral shape by the folded portions 144. In other words, the laminated busbar 140 is formed by overlapping a thin plate in a roll shape.

Both sides of the plurality of busbars 42 may be linked alternately in a lamination direction by the folded portions 144. In other words, the laminated busbars 42 may be linked by alternately repeating a folded portion, which is a valley fold, on one side and a folded portion, which is a mountain fold, on the other side.

Further, the laminated busbar 140 is further provided with holding pieces 146 for holding the plurality of busbars 42 in the laminated state. That is, it is assumed that, out of the plurality of busbars 42, the busbar exposed on one side in the lamination direction is referred to as a first outer busbar 42a and the busbar exposed on the other side is referred to as a second outer busbar 42b. The other busbars 42 are located between the first and second outer busbars 42a, 42b. The holding piece 146 is bent to extend from a side edge of the first outer busbar 42a toward the outer surface of the second outer busbar 42a through the outside of side edges of the intermediate busbars 42. Thus, the holding piece 146 functions to hold the first and second outer busbars 42a, 42b to keep a fixed interval.

In this embodiment, the holding pieces 146 are formed on both ends of the laminated busbar 140. Further, the holding pieces 146 are located closer to a center in the extension direction of the laminated busbar 140 than the fixing holes 42h1, 42h2.

The holding pieces 146 can function to suppress springback by the folded portions 144. That is, if the thin plate is bent at the folded portions 144, openings are possibly formed between the busbars 42 by springback after bending. By holding the interval between the first and second outer busbars 42a, 42b constant by the folded portions 144, the springback of the folded portions 144 is suppressed and the plurality of busbars 42 are easily held in a more densely laminated state.

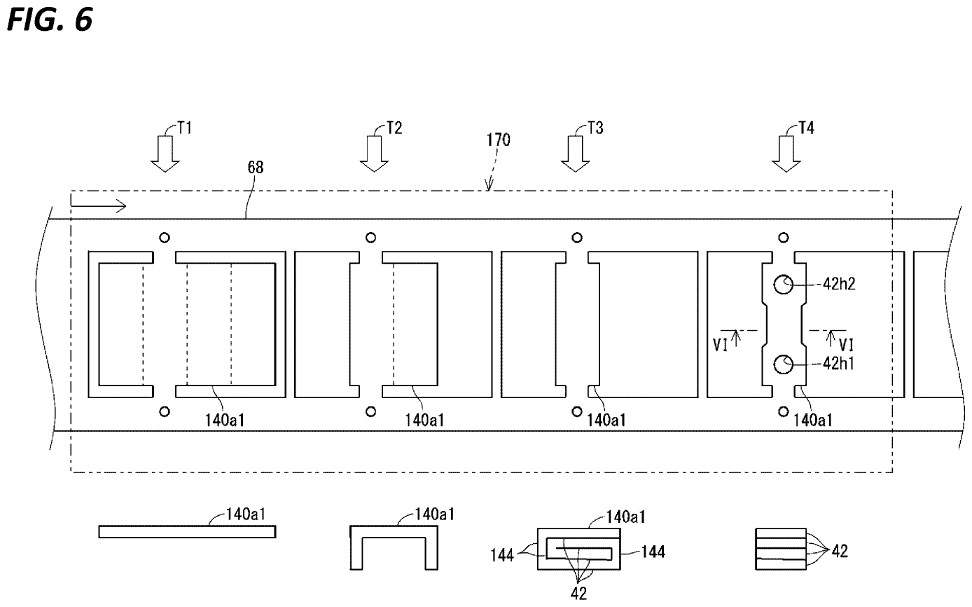

FIG. 6 shows an example of a manufacturing method of the laminated busbar 140. In FIG. 6, bent shapes by press working are shown in accordance with punched shapes. The bent shape in a stage T4 is a shape along VI-VI in FIG. 6.

For example, thin plates pulled out from a plurality of thin plate coils are laminated and consolidated into one. Laminated thin plates 68 are fed to a progressive die device 170.

In a first stage T1 of the progressive die device 170, the plurality of thin plates 68 moving in the laminated state are punched into a shape corresponding to a developed shape of the laminated busbar 140. The developed shape is a shape developed into a plane with the plurality of busbars 42 linked by the folded portions 144 and the like. Parts of the outer peripheries of busbar developed shape parts 140a remain to be coupled to the thin plates 68, whereby the punched busbar developed shape parts 140al can move in the laminated state in the progressive die device 170 together with the thin plates 68.

In a second stage T2 of the progressive die device 170, the laminated busbar developed shape parts 140al are press-worked to be bent toward the one side in the lamination direction.

Subsequently, in a third stage T3 of the progressive die device 170, the laminated busbar developed shape parts 140al are further press-worked to be bent toward the one side in the lamination direction. In the different stages T2, T3, press working is repeated, whereby the busbar developed shape parts 140a are bent into a roll shape. If many busbars 42 are laminated, it is assumed that press working is further repeated.

A work process including a punching step also includes a step of maintaining the laminated state of the laminated busbar 40. This contributes to a reduction in the manufacturing cost of the laminated busbar 140, a reduction in working steps and a reduction in facility cost.

Further, although not shown in FIG. 6, the holding pieces 146 may be formed by performing press working as in the stages T3, T4.

In the fourth stage T4 of the progressive die device 170, the fixing holes 42h1, 42h2 are collectively punched in the busbar developed shape parts 140a1 bent into a roll shape. At this time, collective punching may be applied to both side parts of the busbar developed shape parts 140a1 bent into a roll shape except both ends. In this way, the folded portions 144 can be left on the both ends in the extension direction of the laminated busbar 140, and the folded portions can be removed in the other parts.

Functions and effects similar to those of the laminated busbar 40 are obtained also by the laminated busbar 140 of the second embodiment. In addition, since the plurality of busbars 42 are linked by the folded portions 144, the fixing holes 42h1, 42h2 are easily collectively punched. Further, during and after collectively punching, the fixing holes 42h1 or 42h2 are hardly shifted in position, and the laminated state of the plurality of busbars 42 is easily held.

Further, if the folded portions 144 are formed in a part in the extension direction of the laminated busbar 140, the plurality of busbars 42 are held in the laminated state in the part formed with the folded portions 144 and the plurality of busbars 42 are easily deformed to pass each other in other parts.

Particularly, if the folded portions 144 are formed lateral to the fixing holes 42h1, 42h2, the fixing holes 42h1 or 42h2 are hardly shifted in position. The laminated busbar 140 can be easily deformed in parts of the laminated busbar 140 where the fixing holes 42h1, 42h2 are absent.

Further, the plurality of busbars 42 are easily held in the laminated state by the holding pieces 146.

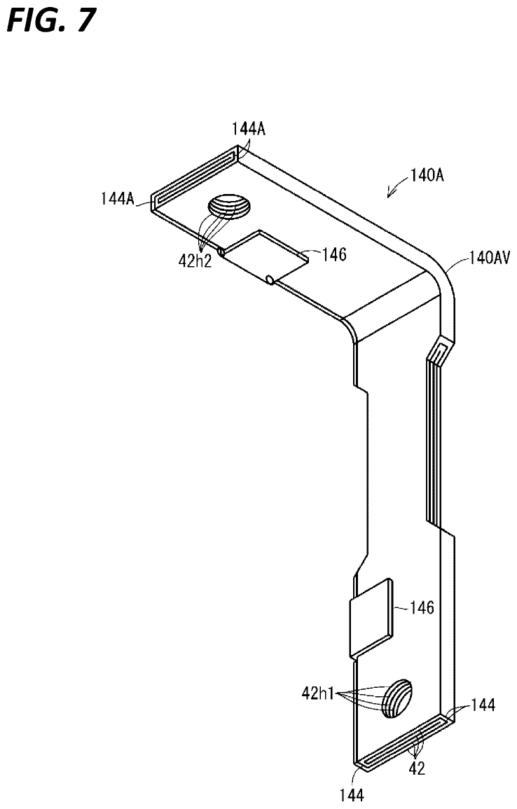

FIG. 7 is a perspective view showing a laminated busbar 140A according to a modification of the second embodiment.

In this modification, an intermediate part in an extension direction of the laminated busbar 140A is bent at a bent portion 140AV. More specifically, a part between a center and one end in the extension direction of the laminated busbar 140A is bent at 90°. Folded portions 144A corresponding to the folded portions 144 are formed in lateral regions of the bent portion 140AV. More specifically, the folded portions 144A on one end side extend from a lateral region of the fixing holes 42h1 to the lateral region of the bent portion 140AV. A region free from the folded portions is present between the folded portions 144A and folded portions 144 on the other end of the laminated busbar 140A.

According to this modification, since the folded portions 144A are present in the lateral regions of the bent portion 140AV, the busbars 42 are hardly shifted in position at the bent portion 140AV. Thus, for example, when the bent portion 140AV is formed after the folded portions 144A are formed, position shifts of the busbars 42 can be suppressed. In this way, the laminated busbar 140A is formed in which the positions of the ends of the busbars 42 are aligned as much as possible.

In this case, the fixing holes 42h1, 42h2 may be formed before the bent portion 140AV is formed or may be formed after the bent portion 140AV is formed. If the fixing holes 42h1, 42h2 are collectively punched after the bent portion 140AV is formed, the positions of the fixing holes 42h1 or 42h2 are easily aligned. Even if the fixing holes 42h1, 42h2 are collectively punched before the bent portion 140AV is formed, the fixing holes 42h1 or 42h2 are less likely to be shifted in position as compared to the case where the folded portions 144A are absent.

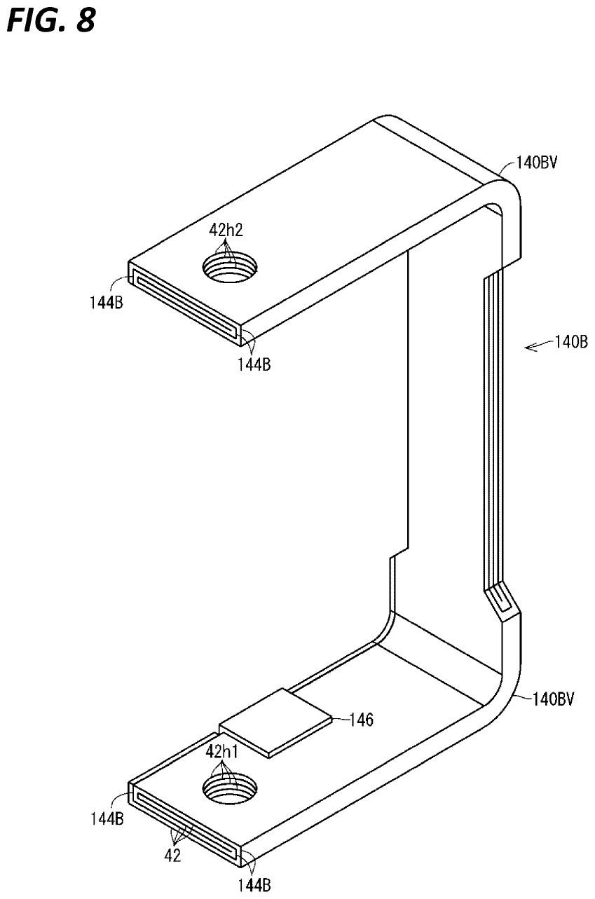

FIG. 8 is a perspective view showing a laminated busbar 140B according to another modification of the second embodiment.

In this modification, intermediate parts at two positions in an extension direction of the laminated busbar 140B are bent at bent portions 140BV. More specifically, a part between a center and one end in the extension direction of the laminated busbar 140B is bent at 90°, and a part between the center and the other end in the extension direction of the laminated busbar 140B is bent at 90°. The one end and the other end of the laminated busbar 140B are bent to extend in the same direction with respect to a part therebetween. Folded portions 144B corresponding to the folded portions 144 are formed in lateral regions of the two bent portions 140B. More specifically, the folded portions 144B on one end side and the other end side extend from lateral regions of the fixing holes 42h1 or 42h2 to lateral regions of the bent portions 140BV. Regions free from the folded portions are present between the folded portions 144B on the one end side and the folded portions 144B on the other end.

Also in this modification, the busbars 42 are hardly shifted in position at the bent portions 140B. Thus, for example, when the bent portions 140BV are formed after the folded portions 144B are formed, position shifts of the busbars 42 can be suppressed. In this way, the laminated busbar 140B is formed in which the positions of the ends of the busbars 42 are aligned as much as possible.

Note that, as in the above modification, the fixing holes 42h1, 42h2 may be formed before the bent portions 140BV are formed or may be formed after the bent portions 140BV are formed.

### Third Embodiment

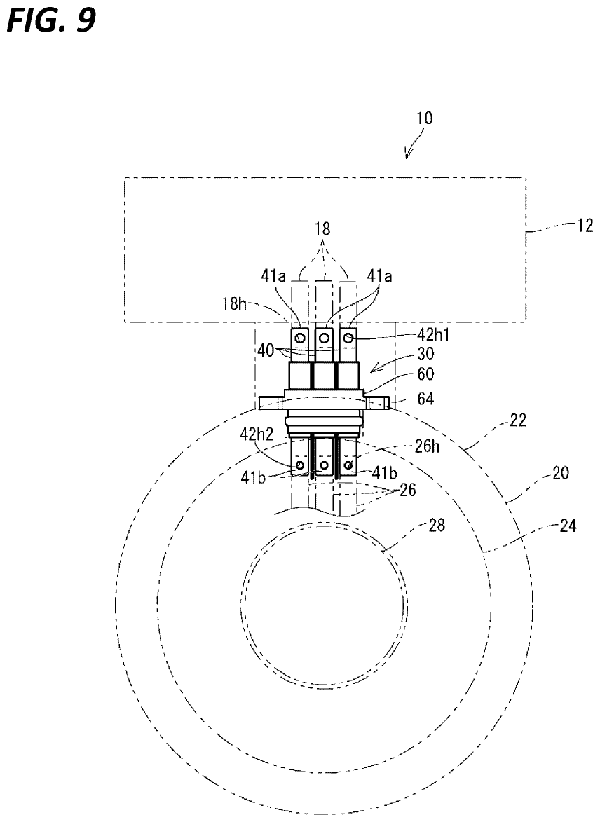

A terminal block according to a third embodiment is described. FIG. 9 is a schematic diagram showing a mechanical and electrical integration unit 10 incorporated with a terminal block 30 including laminated busbars 40.

The overall configuration of the mechanical and electrical integration unit 10 as one application example of the laminated busbars 40 is described. The mechanical and electrical integration unit 10 is provided with a rotating electric machine 20 and an inverter 12.

The rotating electric machine 20 is provided with a case 22, an armature 24 and a field magnet 28. FIG. 9 shows an example in which the armature 24 serving as a stator is fixed in the tubular case 22. The field magnet 28 is arranged as a rotor in the armature 24. The field magnet 28 is rotated by a magnetic field generated by the armature 24 or the armature 24 generates an electromotive force by the rotation of the field magnet 28. In this embodiment, it is assumed that the rotating electric machine 20 is a rotating electric machine usable as a three-phase alternating current motor. The rotating electric machine may be operable as a generator in addition to or instead of an operation as a motor. The rotating electric machine is an example of a device.

The armature 24 includes a stator core and a plurality of coil wires. The stator core includes a plurality of teeth, and the plurality of teeth are provided to surround a rotary shaft. Each coil wire is wound around one or more teeth. Out of a plurality of end parts of the plurality of coil wires, at least some are pulled out to one axial end side of the armature from between the plurality of teeth.

The armature 24 includes coil connection ends 26. The coil connection end 26 is, for example, an elongated electrically conductive plate-like part. The coil connection end 26 is arranged on the one axial end side of the armature 24. The coil connection end 26 is formed with a screw insertion hole 26h for screwing. The coil connection end 26 may be an end part itself of the coil wire or a metal plate connected to the coil wire by welding, screwing or the like. In this embodiment, three coil connection ends 26 corresponding to three phases are arranged at intervals in parallel on one end side of the armature 24. The coil connection end 26 is an example of an electrical component serving as a connection destination of the laminated busbar 40.

Further, the inverter 12 is a device including an inverter circuit. The inverter 12 is assumed to be integrated with the rotating electric machine 20. For example, the inverter 12 is integrated with the case 22 of the rotating electric machine 20 by bolt fixing or the like.

The inverter 12 is provided with inverter-side busbars 18 connected to an output end of the inverter circuit. The inverter-side busbar 18 is an elongated plate-like member made of a metal plate material of copper, copper alloy or the like. The inverter-side busbar 18 is formed with a screw insertion hole 18h for screwing. In this embodiment, three inverter-side busbars 18 corresponding to the three phases extend at intervals in parallel from the inverter 12 toward the rotating electric machine 20. The inverter-side busbar 18 is an example of an electrical component serving as a connection destination of the laminated busbar 40.

The terminal block 30 is a component to be fixed to the case 22 of the rotating electric machine 20 and configured to connect the rotating electric machine 20 and the inverter 12.

The terminal block 30 is provided with the laminated busbars 40 and a block body 60.

The terminal block 30 is a component molded from resin or the like and fixed to the case 22 by screwing or the like.

An intermediate part in the extension direction of the laminated busbar 40 is held by the block body 60. For example, the block body 60 is thought to be molded with sections of the intermediate part in a longitudinal direction of the laminated busbars 40 as insert parts. The block body 60 includes, for example, a screwing portion 64 having screw insertion holes, and screws are screwed and fastened to the case 22 by being inserted through the screw insertion holes. A first connection end 41a of the laminated busbar 40 extends to the outside of the case 22 from the block body 60. A second connection end 41b of the laminated busbar 40 extends to the inside of the case 22 from the block body 60.

In this embodiment, the terminal block 30 is provided with three laminated busbars 40. The terminal block 30 only has to be provided with at least one busbar. The laminated busbar 40 is, for example, the laminated busbar described in the first embodiment. The laminated busbars 140, 140A or 140B described in the second embodiment or the modification thereof may be held in the terminal block 30. The laminated busbar 40 includes the first connection end 41a and the second connection end 41b.

The first connection end 41a is an end part facing outward of the case 22, out of the laminated busbar 40. The first connection end 41a is supported at a position connectable to an end part of the busbar 18 of the inverter 12 while facing outward of the case 22. The first connection end 41a is arranged at a position overlapping the busbar 18 with the inverter 12 integrated with the rotating electric machine 20.

The second connection end 41b is an end part facing inward of the case 22, out of the laminated busbar 40. The second connection end 41b is facing the inside of the case 22 and connected to an end part of the coil connection end 26. The second connection end 41b is arranged at a position overlapping the coil connection end 26 with the terminal block 30 fixed to the case 22.

In this embodiment, the three laminated busbars 40 corresponding to the three phases are arranged at intervals in parallel. The number of the laminated busbars 40 is arbitrary.

With the end part of the busbar 18 overlapped on the first connection end 41a, the screw is inserted through the screw insertion hole 18h and the fixing hole 42h1. Then, the screw is screwed and fastened to a nut. Then, the first connection end 41a and the end part of the busbar 18 are sandwiched between a head part of the screw and the nut and the both are fixed while being electrically connected.

With the coil connection end 26 overlapped on the second connection end 41b, the screw is inserted through the screw insertion hole 26h and the fixing hole 42h2. Then, the screw is screwed and fastened to a nut. Then, the second connection end 41b and the coil connection end 26 are sandwiched between a head part of the screw and the nut and the both are fixed while being electrically connected.

When the inverter 12 is integrated with the rotating electric machine 20, the end parts of the busbars 18 and the first connection ends 41a of the laminated busbars 40 are thought to be shifted in position within a range of assembly tolerances. Further, with the inverter 12 integrated with the rotating electric machine 20, the end parts of the busbars 18 and the first connection ends 41a of the laminated busbars 40 are thought to be shifted in position by thermal expansion/contraction.

This terminal block 30 can function to absorb position shifts between the end parts of the busbars 18 and the first connection ends 41a of the laminated busbars 40, for example, by the laminated busbars 40 being so bent and deformed in a thickness direction that the busbars 42 pass each other.

Further, the coil connection ends 26 may be arranged to deviate from predetermined positions within the range of assembly tolerances. Further, the coil connection ends 26 may be arranged to deviate from predetermined positions due to thermal expansion/contraction or the like. Thus, the coil connection ends 26 and the second connection ends 41b of the laminated busbars 40 may be shifted in position. Also in this case, the busbars 42 can be deformed to absorb position shifts.

This terminal block 30 may function to absorb position shifts between the coil connection ends 26 and the second connection ends 41b of the laminated busbars 40 in addition to or instead of a function to absorb the position shifts between the end parts of the busbars 18 and the first connection ends 41a of the laminated busbars 40.

According to this terminal block 30, the terminal block 30 to be fixed to the rotating electric machine 20 includes the block body 60 to be fixed to the rotating electric machine 20 while holding the laminated busbars 40. Thus, if the first connection ends 41a of the laminated busbars 40 and the busbars 18 are shifted in position or if the second connection ends 41b and the coil connection ends 26 are shifted in position, those position shifts can be absorbed by the deformation of the laminated busbars 40.

An application target example of the laminated busbar 40 is not limited to the configuration according to the third embodiment and the laminated busbar 40 can be applied for electrical connection.

Note that the respective configurations described in the above respective embodiments and the respective modifications can be appropriately combined without contradicting each other.

### LIST OF REFERENCE NUMERALS

10 mechanical and electrical integration
12 inverter
18 inverter-side busbar
18h, 26h screw insertion hole
20 rotating electric machine (device)
22 case
24 armature
26 coil connection end
28 field magnet
30 terminal block
40, 140, 140A, 140B laminated busbar
40a1 busbar outer shape part
41a first connection end
41b second connection end
42 busbar
42a first outer busbar
42b second outer busbar
42g burr accommodating portion
42h1, 42h2 fixing hole
42p shear burr
42v scratch
50 lamination holding member
60 block body
64 screwing portion
68 thin plate
70, 170 progressive die device
140AV, 140BV bent portion
140a1 busbar developed shape part
144, 144A, 144B folded portion
146 holding piece
R1, R2 lateral region

1. A laminated busbar formed into a long shape, comprising a plurality of busbars laminated,
each of the plurality of busbars including a fixing hole,
inner peripheral surfaces of the fixing holes of the plurality of respective busbars being continuous along a lamination direction of the plurality of busbars, the inner peripheral surfaces forming a surface shape collectively punched with the plurality of busbars laminated,
the laminated busbar further comprising a folded portion linking the plurality of busbars,
the folded portion including a first folded portion formed in a part in an extension direction of the laminated busbar and a second folded portion formed in another part in the extension direction and separated from the first folded portion in the extension direction,
the fixing hole being formed in each of both ends in the extension direction of the laminated busbar,
the first folded portion being formed in a lateral region of the fixing hole at one end of the laminated busbar and the second folded portion being formed in a lateral region of the fixing hole at the other end of the laminated busbar in the extension direction,
a side surface of a part between the first folded portion and the second folded portion, out of a lateral region of the laminated busbar, forms a surface shape collectively punched,
the laminated busbar being bent at a bent portion in an intermediate part in the extension direction of the laminated busbar, and
the folded portion being formed in a lateral region of the bent portion.

2. The laminated busbar of claim 1, wherein:
at least one of the plurality of busbars includes a shear burr located on an edge of the fixing hole,
at least one of the plurality of busbars includes a burr accommodating portion on an edge of the fixing hole, the shear burr being located in the burr accommodating portion, and
the inner peripheral surfaces of the fixing holes of the plurality of respective busbars are continuous along the lamination direction with the shear burr located in the burr accommodating portion.

3. (canceled)

4. (canceled)

5. (canceled)

6. (canceled)

7. The laminated busbar of claim 1, wherein:
the plurality of busbars include a first outer busbar exposed on one side in the lamination direction and a second outer busbar exposed on the other side in the lamination direction, and
the laminated busbar further comprises a holding piece for holding the plurality of busbars in a laminated state by extending from a side edge of the first outer busbar toward an outer surface of the second outer busbar.

8. A terminal block to be fixed to a device, comprising:
the laminated busbar of claim 1, and
a block body to be fixed to the device while holding the laminated busbar.
